(19) United States
(12) Patent Application Publication
(10) Pub. No.: US 2024/0287806 A1
(43) Pub. Date: Aug. 29, 2024

(54) POLYMER FILM

(71) Applicant: JOHNS MANVILLE, Denver, CO (US)

(72) Inventors: Jordan Kortmeyer, Parker, CO (US); Jonas Houchin, Centennial, CO (US); Diego Pedrazzoli, Littleton, CO (US); Clayton Christian, Lakewood, CO (US)

(21) Appl. No.: 18/114,008

(22) Filed: Feb. 24, 2023

(51) Int. Cl. E04D 5/14; B32B 7/12; B32B 25/08; B32B 25/16; B32B 37/12; B32B 38/16; E04D 5/10

(52) U.S. Cl. CPC E04D 5/149; B32B 7/12; B32B 25/08; B32B 25/16; B32B 37/1207; B32B 38/162; E04D 5/10; B32B 2250/03; B32B 2307/7376; B32B 2307/748; B32B 2309/02; B32B 2319/00; B32B 2419/06

(57) ABSTRACT

A roofing system may include a first ethylene propylene diene terpolymer (EPDM) roofing membrane having a first lap. The roofing system may include a second EPDM roofing membrane having a second lap that overlaps at least a portion of the first lap of the first roofing membrane. The roofing system may include a thermoplastic film positioned between the first lap and the second lap. The thermoplastic film may bond the first lap and the second lap together.

### BACKGROUND OF THE INVENTION

Roofing membranes are commonly used for roofing systems of building and structures. Roofing membranes are often applied to the building or structure's roof to prevent leaks and/or provide aesthetic appeal. Roofing membranes are commonly made of various synthetic rubber materials, modified bitumen, or thermoplastic materials.

Individual sections of roofing membranes are often required to be bonded or secured to other objects, including metal, roofing accessories, or other roofing membranes. To do so, the edges of the roofing membranes are primed or prepared and then applied with tape before being placed in contact with the target attachment area. The process of priming, preparing, and taping is a laborious task that often takes additional manpower, in addition, the success of the method described is dependent on weather conditions. Therefore, improvements in techniques for securing roofing membranes are desired.

### BRIEF SUMMARY OF THE INVENTION

Embodiments of the present technology may encompass roofing systems that include a first ethylene propylene diene terpolymer (EPDM) roofing membrane having a first lap. The systems may include a second EPDM roofing membrane having a second lap that overlaps at least a portion of the first lap of the first roofing membrane. The systems may include a thermoplastic film positioned between the first lap and the second lap. The thermoplastic film may bond the first lap and the second lap together.

In some embodiments, bonding provided by the thermoplastic film may be heat-activated. The thermoplastic film may have a thickness between 5 mils and 30 mils. The at least the portion of the second lap that overlaps the first lap may be compressed relative to a remaining portion of each of the first EPDM roofing membrane and the second EPDM roofing membrane. The systems may include a third EPDM roofing membrane including a third lap that overlaps at least a portion of one or both of the first EPDM roofing membrane and the second EPDM roofing membrane. The thermoplastic film may provide a bond strength of between about 1 force pound and 50 force pounds using the ASTM D 1876 T-peel test. Each of the first lap and the second lap may include an end lap or a side lap.

Some embodiments of the present technology may encompass methods for coupling roof membranes that include positioning a first EPDM roofing membrane atop a roofing structure, the first EPDM roofing membrane comprising a first lap. The methods may include positioning a thermoplastic film atop the first lap. The methods may include positioning a second EPDM roofing membrane atop the roofing structure such that a second lap of the second EPDM roofing membrane at least partially overlaps the first lap and the thermoplastic film. The methods may include applying heat to the first lap, the second lap, and the thermoplastic film to bond the first lap to the second lap.

In some embodiments, the methods may include applying pressure to the first EPDM roofing membrane, the thermoplastic film, and the second EPDM roofing membrane after positioning the second EPDM roofing membrane. The pressure may be applied using one or both of a roller and a weighted pad. The pressure may compress the lap, the second lap, and the thermoplastic film relative to remaining portions of each of the first EPDM roofing membrane and the second roofing membrane. The pressure and the heat may be applied at least substantially simultaneously. The methods may include flattening one or both of the first roofing membrane and the second roofing membrane prior to applying the heat. The heat may be applied using one or more heat application techniques selected from the group consisting of infrared radiation, heated air, induction heating, and via a heated weight. The heat may be applied at a temperature of between 200° F. and 1148° F. The methods may include cleaning one or both of the first lap and the second lap using a cleaning agent. The methods may include applying heat to the thermoplastic film and the first lap prior to positioning the second roofing membrane to secure the thermoplastic film to the first lap.

Some embodiments of the present technology may encompass EPDM roofing membranes that include a main body. The main body may include a first lap. The main body may include a second lap positioned opposite the first lap. The membranes may include a thermoplastic film that is thermally bonded to the first lap.

In some embodiments, the thermoplastic film may be secured to a top surface of the first lap. The thermoplastic film may be configured to thermally bond the first lap with an additional EPDM roofing membrane without use of other adhesive materials.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a roofing system according to embodiments of the present invention.

FIG. 2 illustrates a perspective view of an embodiment of a roofing membrane.

FIG. 3A illustrates a perspective view of an embodiment of the roofing membrane of FIG. 2 with a thermoplastic film.

FIG. 3B illustrates a perspective view of an embodiment of the roofing membrane of FIG. 2 with a thermoplastic film.

FIG. 3C illustrates a perspective view of an embodiment of the roofing membrane of FIG. 2 with a thermoplastic film.

FIG. 4 illustrates a perspective view of an embodiment of the roofing membrane of FIG. 2, the thermoplastic film, and an object.

FIG. 5 illustrates a side view of the embodiment of the roofing membrane, the thermoplastic film, and an object of FIG. 4.

FIG. 6A illustrates a side view of an embodiment of an exemplary heat welder.

FIG. 6B illustrates a side view of an embodiment of an applicator.

FIG. 7 illustrates a method of securing a roofing membrane to an object using a thermoplastic film.

FIG. 8 illustrates a perspective view of an embodiment of a roofing membrane of FIG. 2 with a thermoplastic film.

FIG. 9 illustrates a perspective view of a first roofing membrane secured to a second roofing membrane using a thermoplastic film.

FIG. 10 illustrates a side view of the embodiment of FIG. 9.

FIG. 11 illustrates a perspective view of an embodiment of a roofing membrane of FIG. 2 with a thermoplastic film.

FIG. 12 illustrates a perspective view of a first roofing membrane secured to a second roofing membrane using a thermoplastic film.

FIG. 13 illustrates a side view of the embodiment of FIG. 12.

FIG. 14 illustrates a method of securing a first roofing membrane to a second roofing membrane using a thermoplastic film.

FIG. 15 illustrates a perspective view of a roofing membrane of FIG. 2 secured to a metal object using a thermoplastic film.

FIG. 16 illustrates a side view of the embodiment shown in FIG. 15.

FIG. 17 illustrates a method of securing a first roofing membrane to a metal object using a thermoplastic film.

FIG. 18 is a chart illustrating peel strengths of a cleaned EPDM membrane and a non-cleaned EPDM membrane.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION OF THE INVENTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Low slope or flat roofs are typically covered with waterproofing materials. For example, some roofs use a “singly-ply” membrane to waterproof a roof. A single ply membrane may be a large, flat, flexible membrane supplied on a roll. In use, the membrane is rolled out on top of the roof, typically on top of the insulation layer. The term “single-ply” is used to describe a roof having a single application of a membrane, but the membrane itself may comprise multiple layers such as polymer layers, reinforcing layers, adhesive layers, coatings, and the like. Typical base materials used for single ply membranes are thermoplastic polyolefin (TPO), ethylene propylene diene monomer (EPDM), polyvinyl chloride (PVC), and modified bitumen. In addition to waterproofing, such roofing membranes are commonly installed for various functional and/or aesthetic purposes. For example, roofing membranes may be installed to provide weather proofing, reduce urban heat island effects via heat reflection, reduce UV damage, reduce roof maintenance and/or degradation, improve weathering characteristics, and the like. Roofing membranes may also be used for aesthetic purposes, including providing a desired roof appearance, such as a uniform color or style.

Roofing systems often include various materials and/or layers in addition to the roofing membranes. These layers/materials are typically positioned under the roofing membrane and may include support members (e.g., wood and/or metal beams), insulation layers (e.g., foam and/or other insulating boards), and/or other boards or members. Traditionally, the roofing membrane may be coupled with one or more of these materials via ballasting, mechanically fastening, adhesive bonding, heat welding, and the like. Embodiments described herein may be used to supplement or replace existing methods, such as those described above.

Conventional roofing membranes are typically coupled together by overlapping adjacent edges, preparing or priming one or more edges, and then using an adhesive material to bond the adjacent edges or heat welding the adjacent edges together. In priming or preparing the edges, the installer must wait for the primer material to flash before applying the adhesive. Improper application of the primer and/or adhesive may result in an improper bond, which may create immediate and/or long-term roofing problems, such as leakage. Human error, such as non-uniform application of the primer and/or adhesive material, may also result in inadequate or insufficient membrane adhesion, which may create short term and/or long-term problems. These and other issues may be reduced or eliminated via the roofing membrane embodiments described herein.

Roofing membranes constructed of EPDM are traditionally coupled using the overlapping and adhesive material bonding as described above. The process of applying adhesive is a laborious and weather-sensitive process, requiring multiple installers and good weather in order for the adhesive to properly bond the EPDM roofing membranes to each other, increasing the risk of improper installation. Additionally, the usage of adhesive material may be used to bond roofing membranes to other materials that are typically positioned under or around the roofing membrane, such as support members, (e.g., wood and/or metal beams), insulation layers (e.g., foam and/or other insulating boards), and/or roofing accessories. In such cases, similar issues arise when using adhesive, labor-intensive, weather-sensitive, and prone to improper securement or attachment. Embodiments and methods described herein are directed towards reducing the difficulty of securing roofing membranes to one another as well as securing roofing membranes to other materials typically found in roofing systems.

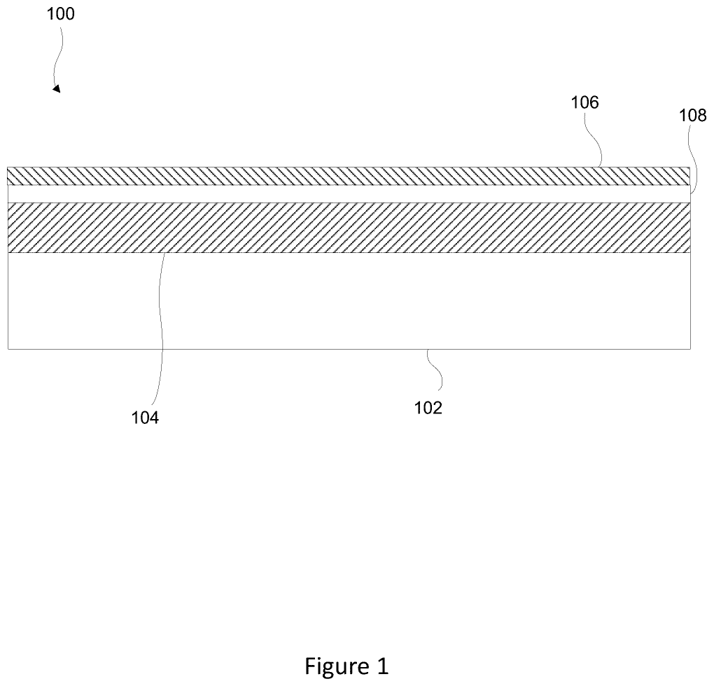

Turning now to FIG. 1, one embodiment of a roof structure 100 is illustrated. Roof structure 100 may include a roof deck 102, which may be formed from various materials such as, but not limited to, steel, concrete, cement and/or wood. Roof deck 102 may serve as a primary substrate on which various insulation and/or weatherproofing layers are supported. Roof structure 100 may include a number of roofing cover boards 104, which may protect the roof deck 102 and/or provide insulation to the roof structure 100. The roofing cover boards 104 may include polyisocyanurate, oriented strand board (OSB), gypsum, and/or other roofing boards. In some embodiments, the cover boards 104 may include a facer, such as a paper facer and/or a glass coated facer. Additional structural and/or insulation layers may be included in some embodiments. A roofing membrane 106 may be positioned atop roof structure, oftentimes above the cover boards 104 and/or other insulation layer, and may be configured to prevent leaks in the roofing structure 100 and/or to provide aesthetic appeal. Typically, the roofing membrane 106 may be in the form of a single ply membrane. It will be appreciated that in some embodiments, multiple layers of roofing membrane 106 may be applied to a single roof structure.

Oftentimes, the roofing membrane 106 may be provided as a roll of flat, flexible membrane that may be rolled out on top of the roof structure. For example, a single ply roofing membrane 106 may be supplied in any workable size (such as, but not limited to, rolls of 10 feet wide or more and containing 100 linear feet or more of roofing membrane 106). Oftentimes, the roof structure may be too large to be covered by a single piece of roofing membrane 106. In such instances, multiple pieces of roofing membrane 106 may be overlapped and joined at the seams using a waterproof joining method. For example, seams of adjacent pieces of roofing membrane 106 may be joined by priming and/or preparing edges of the roofing membranes 106 and then applying a tape to the primed and/or prepared edges, using heat welding and/or using another form of adhesive bonding. In priming or preparing the edges, the installer must wait for the primer material to flash before applying the adhesive. Improper application of the primer and/or adhesive may result in an improper bond, which may create immediate and/or long-term roofing problems, such as leakage. Examples of using and installing single ply roofing membranes 106 may be found in U.S. Patent Publication No. 2016/0362894, entitled “Sheet Roofing with Pre-Taped Seams and Tape Therefor” and filed Aug. 25, 2016, the entire contents of which is hereby incorporated by reference for all purposes.

In some embodiments, roofing membrane 106 may include one or more polymeric membranes and/or other waterproofing layers. For example, a polymeric membrane may form the outer layer of the roof once fully installed and may help prevent leaks in the roofing structure and provide aesthetic appeal to the finished roof. For example, the waterproofing layer often provides a uniform outer surface that provides an aesthetically pleasing finished appearance to the roof. Polymeric membrane 106 may have a white exterior but may be made in various other colors or shades, such as grey, tan, black, and the like. White polymeric membranes are often used to provide a pleasing appeal to the building and/or to reflect radiation and thereby minimize heat island effects. In other embodiments, a black or other dark polymeric membrane may be provided. Such polymeric membranes absorb more radiant heat than white polymeric membranes. Additionally, in the winter, condensation evaporates quicker and snow and ice melt more rapidly on black roofs than white roofs.

In some embodiments, polymeric membranes may be formed of various synthetic rubber materials, modified bitumen, or thermoplastic materials. For example, roofing membrane 106 may commonly include thermoplastic polyolefin (TPO), polyvinyl chloride (PVC), ethylene propylene diene monomer (EPDM), chlorinated polyethylene (CPA), and/or modified bitumen, although some embodiments may use other thermoset and/or thermoplastic roofing membranes. In some embodiments, the polymeric membrane may include one or more polymers blended with one or more fillers. For example, in some embodiments the polymeric membranes may include some combination of the following materials: polypropylene, polyethylene, block copolymer polypropylene, rubber, plasticizers, fiberglass, carbon fiber, fire retardants, and the like. In another embodiment, a polymeric membrane may have a more pure polymer blend without or with very few fillers. For example, the polymeric membrane may include mainly polypropylene or polyethylene or some combination of these polymers with little to no fillers, although in some embodiments, these polymeric membranes may include some amount of a filler, such as a fire retardant. In some embodiments, the polymeric membrane may have a thickness of between about 500 μm to about 3 mm, however other thicknesses are possible in various embodiments.

The roofing membrane 106 may be secured to the roofing structure 100 using a thermoplastic film 108. For example, thermoplastic film 108 may be positioned between the cover boards 104 and the roofing membrane 106. Heat and/or pressure may be applied to the thermoplastic film 108 upon being applied to the roofing structure 100 and/or after applying the roofing membrane 106 atop the thermoplastic film 108. The heat may cause the thermoplastic film 108 to become tacky and stick to the roofing structure 100 and the roofing membrane 106 to bond the roofing membrane 106 to the roofing structure 100. The thermoplastic film 108 may be positioned proximate the edges of the roofing membrane 108 and/or may be positioned under medial portions of the roofing membrane 108. In some embodiments, the thermoplastic film 108 may be substantially coextensive with a bottom surface of the roofing membrane 106 to help bond the entire surface of the roofing membrane 106 to the roofing structure 100.

The thermoplastic film 108 may have a thickness of between about 1 mil and 100 mils, between about 2 mils and 50 mils, between about 3 mils and 40 mils, between about 4 mils and 35 mils, or between about 5 mils and 30 mils. The thermoplastic film 108 may have a substantially uniform thickness across the entire surface area of the thermoplastic film 108. For example, the thermoplastic film 108 may have a thickness that is uniform to within 95%, to within 96%, to within 97%, to within 98%, to within 99%, or more across a surface of the thermoplastic film 108. Thermoplastic film 108 may be activated by applying a sufficient amount of heat to tackify the thermoplastic film 108, which may often be between about 200° F. and 1148° F., although the exact temperature needed may depend on the composition of the thermoplastic film 108 and/or a duration of time that the heat is applied to the thermoplastic film 108.

The thermoplastic film 108 may be formed from various components, which may be selected based on the adhesive compatibility with the roofing membrane 106. For example, in some embodiments, the thermoplastic film 108 may be selected to have a base polymer that matches and/or has a same surface energy as a base polymer of the roofing membrane 106. For example, if the roofing membrane 106 is TPO, the thermoplastic film 108 may include polypropylene. If the roofing membrane 106 is PVC, the thermoplastic film 108 may include polyurethane. If the roofing membrane 106 is EPDM, the thermoplastic film 108 may include polyethylene. Such pairings are merely meant as examples, and it will be appreciated that different formulations of thermoplastic films 108 may be used with different compositions of roofing membranes 106 in various embodiments. Additionally, the thermoplastic film 108 may include polymers other than polypropylene, polyurethane, and polyethylene in various embodiments. In some embodiments, the thermoplastic film 108 may provide a bond strength of between about 1 force pound and 50 force pounds using the ASTM D 1876 T-peel test.

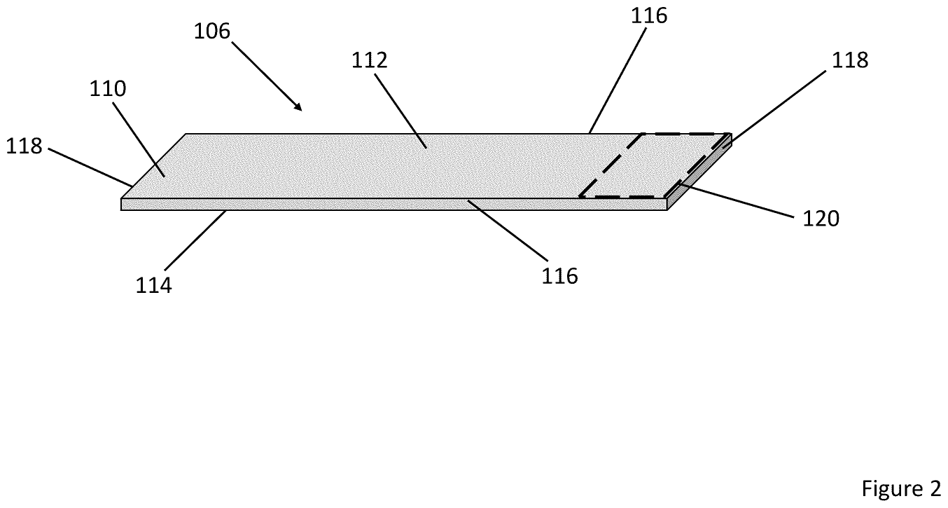

FIG. 2 illustrates one embodiment of roofing membrane 106. The roofing membrane 106 may include a main body 110 having a top surface 112, and a bottom surface 114 positioned opposite the top surface 112. As illustrated, the main body 110 additionally includes four edges, that define an outer perimeter of the main body 110. For example, the main body 110 may include two lateral edges 116 that may define and/or form side laps (e.g., overlapping portions of the side edges 116 of two adjacent roofing membranes 108) and two end edges 118 that may define and/or form end laps (e.g., overlapping portions of the end edges 118 of two adjacent roofing membranes 108). The main body 110 typically has a square or rectangular profile, and, in many instances, the main body 110 may have a lateral width of between 10 feet and 40 feet, a longitudinal length of between about 50 feet and 100 feet, and a thickness of between about 0.045 inches and 0.090 inches. It should be appreciated that the dimensions described above may vary depend on application and/or need. The edges of the roofing membrane 106 may be further defined based on the length of the edges, with short edges being defined as the end laps 118 and the long edges being defined as the side laps 116.

During installation, in addition to or alternatively to coupling the roofing membrane 106 to the roofing structure 100, the roofing membrane 106 may need to be coupled or secured to a variety of other objects, including but not limited to, other roofing membranes, roofing accessories (vents, gutters, etc.), metal plating, wooden roofing foundation, etc. To facilitate coupling of the roofing membrane 106 to such objects of these potential locations (e.g., the side laps 116, end laps 118, and/or any other edges that are adjacent to one or more roofing accessories) may include or serve as one or more discrete attachment surfaces. Referring to FIG. 2, a potential attachment surface 120, positioned at one of the end laps 118, is shown and denoted using dashed lines. The attachment surface 120 is merely exemplary, and a plurality of different size and shaped attachment surfaces are envisioned. Multiple attachment surfaces may be provided on a single roofing membrane 108. For example, in some embodiments, each end lap 118 and/or each side lap 116 may include a respective attachment surface 120. In some embodiments, the attachment surfaces 120 may be disposed on a single surface of the roofing membrane 108 (e.g., on the top surface 112 or the bottom surface 114). In other embodiments, the attachment surfaces 120 may be disposed on different surfaces of the roofing membrane 108. For example, attachment surfaces 120 on each side lap 116 and/or attachment surfaces 120 on each end lap 118 may be on opposing surfaces of the roofing membrane 120. This may enable adjacent roofing membranes to be overlapped and secured in a same manner.

Generally, once an attachment surface 120 is identified, a thermoplastic film 212 may be positioned at the attachment surface 120. The thermoplastic film 212 may be similar to thermoplastic film 108 and may include one or more layers of a thermoplastic material, with a total thickness of the thermoplastic film 212 having a thickness of between about 1 mil and 100 mils (such as between about 5 mils and 30 mils) and may bond, fuse, and/or secure to an object, such as the roofing membrane 106, roofing structure 100, and/or a roofing accessory, when heated to a sufficient temperature that causes the thermoplastic film 212 to become tacky. Such temperatures may depend on the composition of the thermoplastic film 212, but may often be between about 200° F. and 1148° F. Generally, the thermoplastic film 212 may be positioned between roofing membrane 106 and another object (such as a second roofing membrane, a roofing accessory, metal plate, etc.) as to thermally bond or laminate the materials together without the use of other adhesive materials (e.g., wet/chemical-based adhesives, tapes, primers, glues, epoxies, tackified/self-stick polymers, etc.). In some embodiments, the thermoplastic film 212 may be reinforced with a reinforcement layer, such as a polyester scrim, for strength and to prevent unwanted stretching and/or breaking, in particular during the process of securing the thermoplastic film 212 to an EPDM membrane and/or other object.

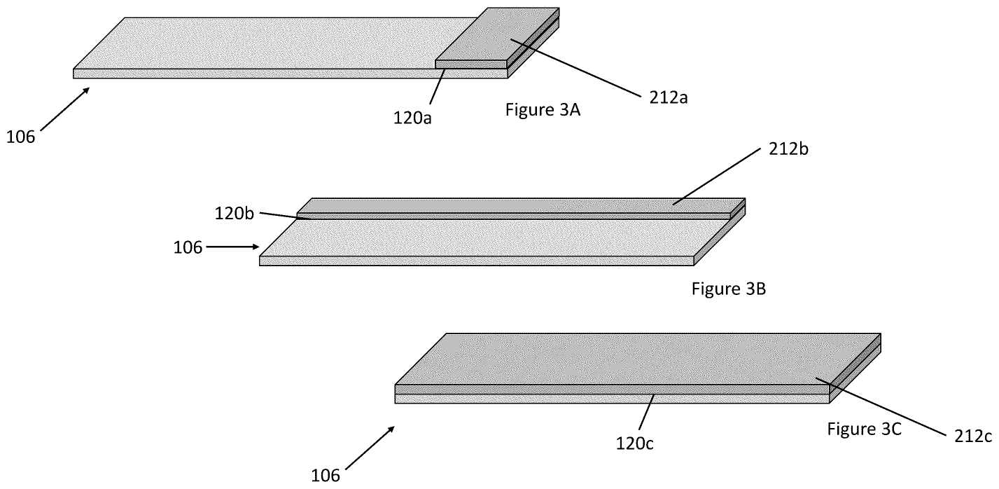

As discussed above, roofing membranes 106 are often secured or adhered to other objects in order to provide weather proofing, reduce urban heat island effects via heat reflect, reduce UV damage, reduce roof maintenance and/or degradation, and improve weathering characteristics as few examples. Therefore, it is envisioned that a variety of attachment positions/surfaces 120 may be used when positioning the thermoplastic film 212 on the roofing membrane 106. FIGS. 3A-3C depict a perspective view of a roofing membrane 106 with a thermoplastic film 212 positioned at a variety of different attachment surfaces 120 of the roofing membrane 106. FIG. 3A depicts a thermoplastic film 212a at an attachment surface 120a positioned at one of the end laps 118. FIG. 3B illustrates a thermoplastic film 212b at an attachment surface 120b positioned at one the side laps 112. FIG. 3C depicts a thermoplastic film 212c at an attachment surface 120c that is configured to cover an entire surface of the roofing membrane 106. As indicated above, the attachment surfaces 120 may be positioned on the top and/or bottom surface of the roofing membrane 106, depending on the needs of a particular application. The attachment positions shown in FIGS. 3A-3C are merely exemplary and a variety of additional positions for the thermoplastic film 212 based on various applications are envisioned and encompassed within this disclosure.

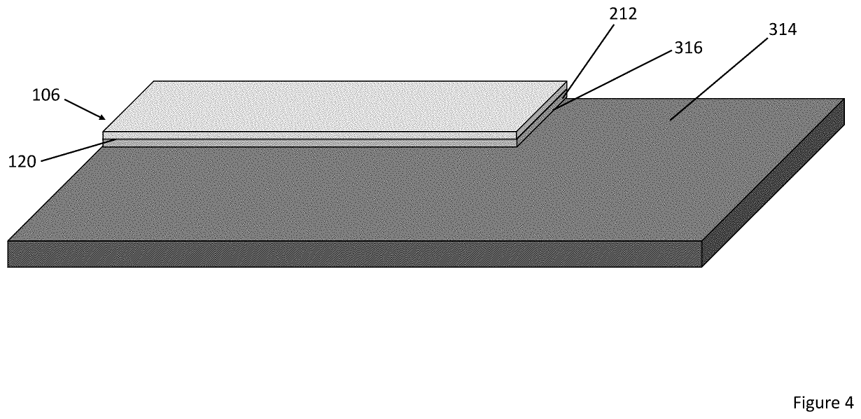

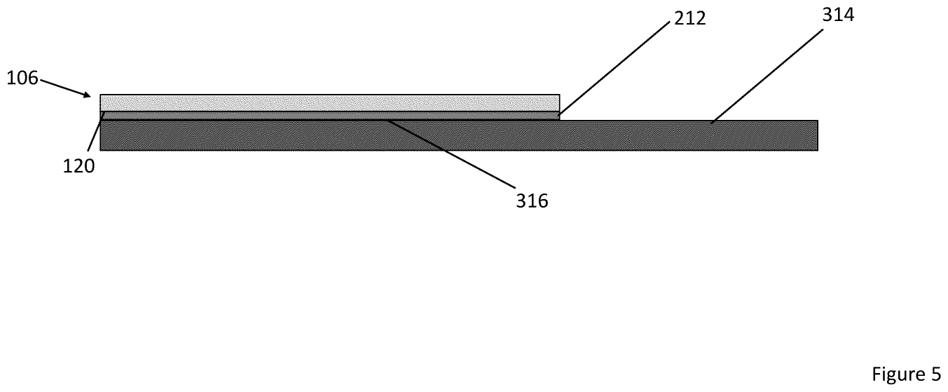

FIG. 4 depicts a perspective view of the thermoplastic film 212 positioned between the attachment surface 120 of the roofing membrane 10606 and a target attachment surface 316 of a target object 314. The target object 314 may be, for example, a roofing membrane, a roof deck, a cover board, a gutter, flashing, support features for objects positioned atop the roof (e.g., solar arrays, antennae, HVAC equipment, etc.), vertical surfaces and/or objects protruding from the roof deck and/or cover boards, and/or other objects. Additionally, and as shown in an alternative view, FIG. 5 depicts a side view of the thermoplastic film 212 positioned between the attachment surface 120 of the roofing membrane 106 and the target attachment surface 316 of the target object 314. The positioning of the thermoplastic film 212 relative to the roofing membrane 1066 and the target object 314 as shown FIG. 4 and FIG. 5 is merely exemplary and is not intended to be limiting. For example, while shown with the roofing membrane 106 positioned atop the target object 314, the roofing membrane 106 may be positioned below the target object 314 in some embodiments. Additionally, while illustrated using the thermoplastic film 212 to bond planar, horizontal surfaces of the roofing membrane 106 and target object 314, it will be appreciated that the thermoplastic film 212 may be used to bond vertical, bent, and/or contoured surfaces of the roofing membrane 106 and target object 314 in various embodiments.

Once positioned at the attachment surface 120 of the roofing membrane 106, the thermoplastic film 212 may be sandwiched between the roofing membrane 106 and the object 314. The thermoplastic film 212 may not be secured or fused to the roofing membrane 106 and/or the object 314 until heat is applied and, therefore, the installer may still move or reposition the roofing membrane 106, the object 314, and/or the thermoplastic film 212 relative to one another. Alternatively, in some embodiments, it may be beneficial to heat the thermoplastic film 212 once the thermoplastic film 212 is applied to one of the attachment surfaces 120, 316 to secure or fuse to the thermoplastic film 212 to one object prior to positioning the second object relative to the thermoplastic film 212. Such securing of the thermoplastic film 212 may make it easier for an installer to position the target object 314 and/or the roofing membrane 106 relative to the thermoplastic film 212. Deciding whether the apply the thermoplastic film 212 first to the roofing membrane 106 or to the object 314 is situational and varies based on application and installation conditions. For example, if the object 314 is significantly larger or secured down (e.g., a roofing cover board), it may be beneficial to initially place the thermoplastic film 212 onto the object 314.

After the objects are satisfactorily positioned by the installer, heat and/or pressure may be applied to bond, fuse, or secure the roofing membrane 106, the thermoplastic film 212, and the target object 314 together. To explain further, as heat is applied, the thermoplastic film 212 will soften and tackify. The tacky surface of the thermoplastic film 212 may come in contact with the attachment surface 120 of the roofing membrane 106 and the target attachment surface 316 of the object 314 and may adhere the attachment surfaces together. As the softened thermoplastic film 212 begins to cool, the attachment surface 120 and the target attachment surface 316 will fuse to the thermoplastic film 212, and, subsequently, be coupled or bonded to one another. The thermoplastic film 212 may be heated between a range of 200° F. up to 1148° F. to tackify the thermoplastic film 212. The temperature may be chosen based on the composition of the thermoplastic film 212, the heat application method, and/or other variables. The heat may be applied in a variety of different methods including but not limited to air/convection heating, infrared heating, induction heating (e.g., when there is metal present under the thermoplastic film 212), conduction heating, etc.

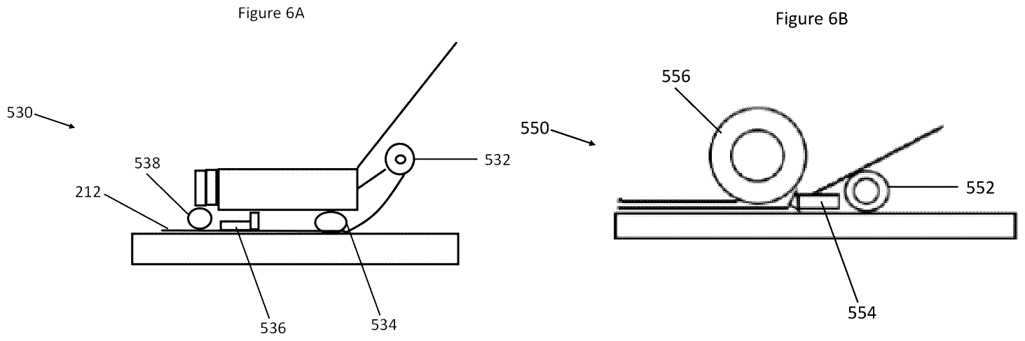

An exemplary heat welder 530 for applying the thermoplastic film 212 to a surface (such as a roof deck and/or cover board) is shown in FIG. 6A. The heat welder 530 as shown may be pulled across the surface and may lay down one or more layers of the thermoplastic film 212 as the heat welder 530 progresses across the surface. The heat welder 530 may include a film dispenser 532 that may dispense the one or more layers of the thermoplastic film 212 atop the surface as the heat welder 530 is rolled atop the surface. A roller 534 may trail the film dispenser 532 and may help flatten the thermoplastic film 212 against the surface. A hot air nozzle 536 (or other heating mechanism) may blow hot air and/or otherwise deliver heat (e.g., infrared heating, induction heating, plate heating, conduction heating, etc.) to the flattened thermoplastic film 212. The heat may be applied at a temperature of between about 200° F. up to 1148° F. in some embodiments. In some embodiments, an amount of air flow delivered by the hot air nozzle 536 may be set to between about 50% and 100% of the capacity of the hot air nozzle 536, although the exact output may depend on various factors, such as the capacity of the hot air nozzle 536, a temperature of the air, a rate of movement of the heat welder 530, a thickness of the thermoplastic film 212, etc. A weighted roller 538 may trail the hot air nozzle 536 to apply pressure to the heated thermoplastic film 212 to help increase adhesion between the thermoplastic film 212 and the surface. The heat welder 530 may be operated by a singular installer who can pull the heat welder 530 backwards across the surface. The heat welder 530 may be moved at a rate of between about 2 ft/min and 30 ft/min in some embodiments. The temperature applied by the heat welder 530 may be adjusted based on a rate of movement of the heat welder 530, with higher temperatures being associated with higher movement rates. The heat welder 530 described is merely provided as one example and it will be appreciated that a variety of tools and machinery may be used to apply heat and/or pressure to the thermoplastic film 212.

FIG. 6B illustrates one example of an applicator 550 that may be used to apply a roofing membrane 106 atop the thermoplastic film 212 (which may be positioned atop a surface such as a roof deck, cover board, other structural feature, and/or another sheet of roofing membrane 106). The applicator 550 as shown may be pulled across the surface and may lay down one or more layers of roofing membrane 106 atop the thermoplastic film 212 as the applicator 550 progresses across the surface. The applicator 550 may include a roller 552 that may flatten the thermoplastic film 212 against the surface. A heating element 554 may heat and tackify the flattened thermoplastic film 212. The heating element 554 may deliver heat via infrared heating, induction heating, plate heating, conduction heating, etc. The heat may be applied at a temperature of between about 200° F. up to 1148° F. in some embodiments. A membrane dispenser 556 may trail the heating element 554 and may lay down one or more layers of the roofing membrane 106 atop the tackified thermoplastic film 212. In some the embodiments, the membrane dispenser 556 may include and/or be trailed by a weighted member that may apply pressure to the roofing membrane 106 to help increase adhesion between roofing membrane 106 and the thermoplastic film 212. The applicator 550 may be operated by a singular installer, who can pull the applicator 550 backwards across the surface. The applicator 550 may be moved at a rate of between about 2 ft/min and 30 ft/min in some embodiments. The temperature applied by the applicator 550 may be adjusted based on a rate of movement of the applicator 550, with higher temperatures being associated with higher movement rates. The applicator 550 described is merely provided as one example and it will be appreciated that a variety of tools and machinery may be used to apply heat and/or pressure to the roofing membrane 106 and the thermoplastic film 212.

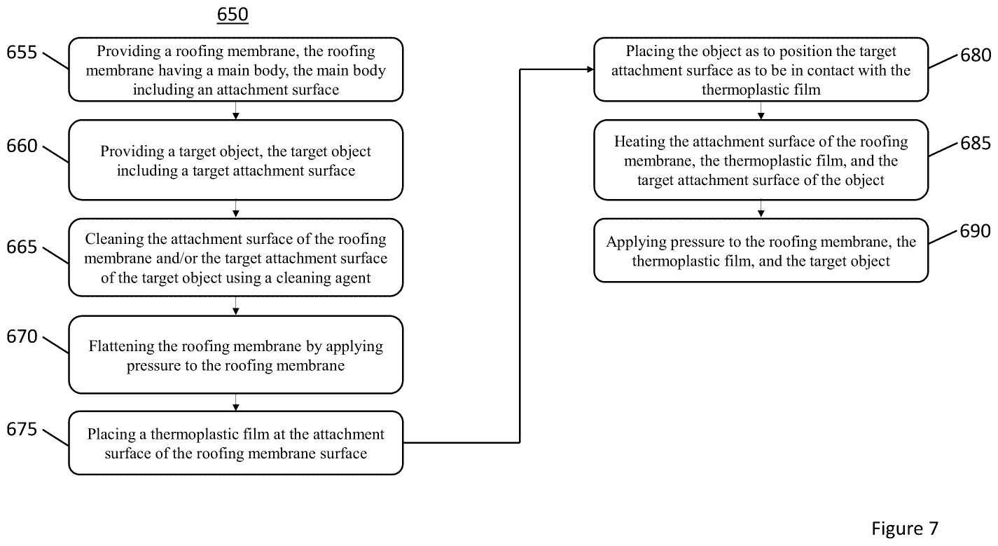

FIG. 7 illustrates one exemplary method for coupling a roofing membrane 106 to a target object 314 using a thermoplastic film 212. As noted above, the thermoplastic film 212 may be used to couple or secure a roofing membrane 106 to one or more roofing materials, which may include support members (e.g., wood and/or metal beams, roof decks, cover boards, flashing, etc.), insulation layers (e.g., foam and/or other insulation boards), other layers of roofing membrane 106, roofing accessories (e.g., a gutter, flashing, support features for objects positioned atop the roof (e.g., solar arrays, antennae, HVAC equipment, etc.), vertical surfaces and/or objects protruding from the roof deck and/or cover boards, and/or other objects), and/or other boards or members. Method 650 as described below may be used to replace or supplement traditionally used method of coupling materials, such as ballasting, mechanically fastening, adhesive bonding, heat welding, and other methods known in the art. It is envisioned that in some embodiments the thermoplastic film 212 may be positioned on the target object 314 instead of on the roofing membrane 106.

The method 650 may include providing a roofing membrane 106 at operation 655. The roofing membrane 106, as described in detail above and shown in FIG. 2, may be constructed of a thermoset material (e.g., ethylene propylene diene monomer (EPDM)) or a thermoplastic material (e.g., PVC, TPO, etc.). The roofing membrane 106 may generally include a main body 110 having a top surface, a bottom surface, and four edges that define an outer perimeter of the main body 110, and typically a rectangular or square profile. Further, one or more attachment surfaces 120 may be defined on the roofing membrane 106 and represents the portion (which may be an entire surface) of the roofing membrane 106 that is to be coupled with the target object 314. As stated above, the roofing membrane 106 shown in FIG. 2 is merely exemplary and a variety of additional shapes and embodiments are envisioned and included within the scope of this disclosure.

The method 650 may include including providing a target object 314 at operation 660. The target object 314 may be the one illustrated in FIG. 6. Further, the target object 314 may be constructed of support members (e.g., roof decks, cover boards, etc.), insulation layers (e.g., foam and/or other insulation boards), roofing accessories, other roofing membranes 106, and/or other boards or members that may be found or associated with roofing and roofing systems. A target attachment surface 316 may be defined on the target object 314 and represents the position (which may include one or more entire surfaces) of the target object 314 with which the roofing membrane 106 is intended to be coupled. As stated above, the target object 314 shown in FIG. 5 is merely provided as one example and a variety of embodiments of the target object 314 are envisioned and included within the scope of this disclosure.

In some embodiments, the method 650 may include cleaning the attachment surface 120 of the roofing membrane 106 and/or cleaning the target attachment surface 316 of the target object 314 at operation 665. In some applications or situations, the roofing membrane 106 and/or the target object 314 may have gathered dirt, dust, residual material from production, damage, or various other imperfections at the attachment surfaces 120, 316. In some embodiments, a cleaning agent is applied to the roofing membrane 106 and the target object 314 to ensure a clean surface where the thermoplastic film 212 will be positioned and bonded. A washrag or an abrasive cleaning tool may be used by an installer in conjunction with the cleaning agent to apply additional abrasive forces to wipe or clean the attachment surface 120 and/or the target attachment surface 316. It is envisioned that operation 665 may include cleaning only a portion of or the entirety of the roofing membrane 106 and/or the target object 314. Additionally, alternative cleaning methods known in the art made be used to clean one or more of the attachment surfaces 120, 316.

The method 650 may include flattening the roofing membrane 106 by applying pressure to the roofing membrane 106 at operation 670. During shipping or manufacturing, roofing membranes 106 may be rolled up, folded, or experience other warping conditions (e.g., excessive heat, moisture, etc.) resulting in an uneven surface. In such cases, it may be beneficial to remove any distortions in the surface of the roofing membrane 106, and, to do so, heat and/or pressure may be applied to the roofing membrane 106 using rollers, weighted pads, and/or other methods known in the art. For example, the applicator as shown in FIG. 6B may be used to flatten the roofing membrane 106. Once flattened, the surface of roofing membrane 106, particularly the attachment surface 120, will provide for a more consistent surface, allowing for a more accurate and consistent bond between the roofing membrane 106 and the thermoplastic film 212. The application of heat during the flattening process may make the roofing membrane 106 more pliable and may enhance the flattening process.

The method 650 may include placing a thermoplastic film 212 at the attachment surface 120 of the roofing membrane 106 at operation 675. Referring to FIGS. 3A-3C, the thermoplastic film 212 may be positioned to the roofing membrane 106 at the attachment surface 120. As noted previously, during placement, the thermoplastic film 212 may be moved or repositioned without the thermoplastic film 212 fusing, sticking, or securing to the attachment surface 120 of the roofing membrane 106. Therefore, during placement and prior to applying heat to the thermoplastic film 212, an installer may remove, move, and/or replace the thermoplastic film 212, allowing for adjustments to be made. In some embodiments, the method 650 may include heating the thermoplastic film 212 to secure the thermoplastic film 212 prior to positioning the thermoplastic film 212 and the roofing membrane 106 adjacent to the target object. Such heating may enable the thermoplastic film 212 to be fixed in a desired position relative to the roofing membrane 106 prior to positioning the target object relative to the roofing membrane 106.

The method 650 may include placing the target attachment surface 316 of the target object 314 in contact with the thermoplastic film 212 at operation 680. The method 650 may include heating the attachment surface 120 of the roofing membrane 106, the thermoplastic film 212, and the target attachment surface 316 of the target object 314 at operation 685. The heat may soften and tackify the thermoplastic film 212 to fuse or bond the roofing membrane 106 and the target object 314. The heat applied may range between 200° F. and 1148° F., with the temperature being chosen based on the various factors, such as a composition and/or thickness of the thermoplastic film 212, a composition and/or thickness of the roofing membranes 106, a duration that the heat is applied, and/or based on other factors. A variety of methods may be used to heat thermoplastic film 212 based on application and conditions. Such methods include, but are not limited to, infrared heating, induction heating, plate heating, conduction heating, etc. In some embodiments, the heat may be applied using a variety of machinery, including heat welders (such as shown in FIG. 6A), applicators (such as shown in FIG. 6B), handheld air guns, handheld irons, infrared heaters, heated pads, heated rollers, and/or other techniques known in the art. For example, if the target object 314 is a large planar surface (such as a roofing deck, cover board, another roofing membrane applied to a planar surface, etc.), the heat welder 530 and/or the applicator 550 described above may be used. However, if the target object 314 is small or irregularly (e.g., non-planar/non-uniform) shaped, such as gutters, flashing, or vents, a handheld heater such as an iron and/or hot air gun, may be more appropriate. These situations are merely provided as examples, and it is envisioned that a variety of tools and machinery may be used with the methods and systems described herein.

The method 650 may include applying pressure to the roofing membrane 106, the thermoplastic film 212, and the target object 314 at operation 690. The pressure may improve adhesion between the thermoplastic film 212 and the target object 314 and/or roofing membrane 106. In some embodiments, the pressure may be applied to additionally flatten the coupling point of the roofing membrane 106 and/or the target object 314. In some embodiments, the pressure may subsequently compress the attachment surface 120 of the roofing membrane 106, the target attachment surface 316 of the target object 314, and the thermoplastic film 212 relative to the rest of the roofing membrane 106 and the target object 314. In some embodiments, the pressure and heat may be applied simultaneously, or substantially simultaneously (e.g., within 5 seconds, within 3 seconds, within 1 second, or less) using a heat welder and/or applicator such as shown in FIGS. 6A and 6B. Alternatively, different machinery and tools may be used in scenarios where the heat welder 530 is not sufficient. For example, if the target object 314 is a gutter or irregular shape, a handheld tool may be appropriate. Pressure may be applied after the thermoplastic film 212 is completely cooled, during the cooling of the thermoplastic film 212, and/or during the heating of the thermoplastic film 212. Depending on the application, it may be beneficial to compress the roofing membrane 106, the target object 314, and the thermoplastic film 212 at different times relative to the heating based on conditions and applications.

A method 1350 is shown in FIG. 13 for coupling a first roofing membrane 106A to a second roofing membrane 106B using a thermoplastic film 212. The use of the thermoplastic film 212 may be used with such a method described below to replace or supplement traditionally used method of coupling materials, such as ballasting, mechanically fastening, adhesive bonding, heat welding, and other methods known in the art. It is envisioned that the first roofing membrane 106A and the second roofing membrane 106B are interchangeable in relation to method 1350. Additionally, method 1350 may provide the significant benefit over existing methods and systems as a singular installer is capable of performing the method as described herein.

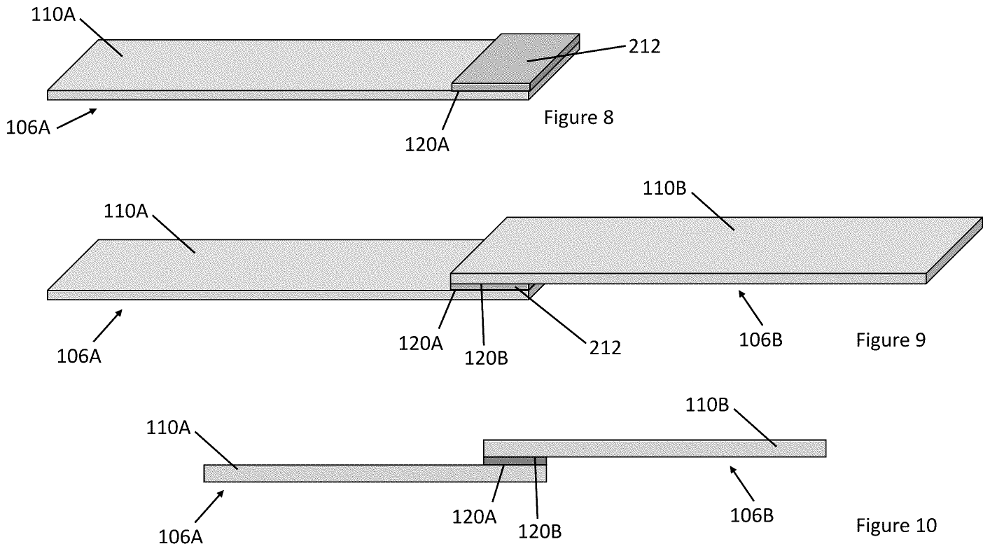

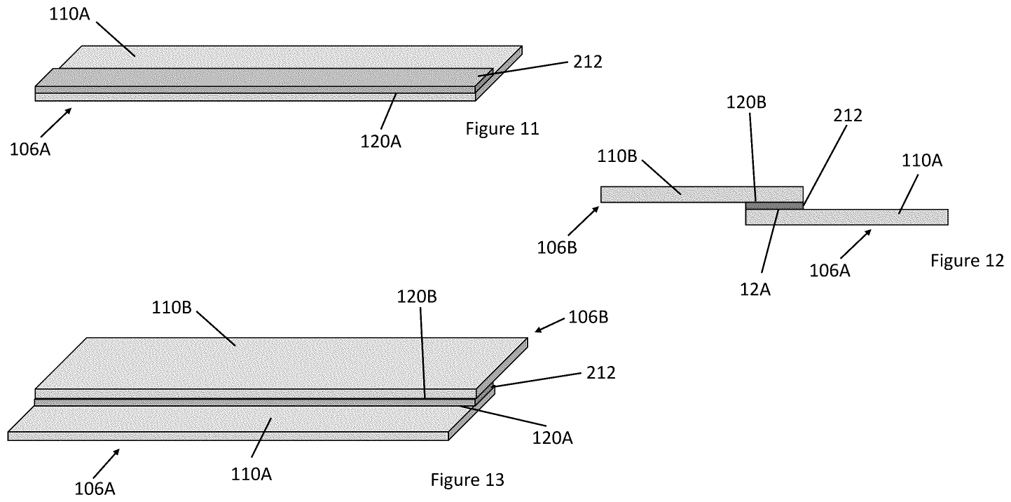

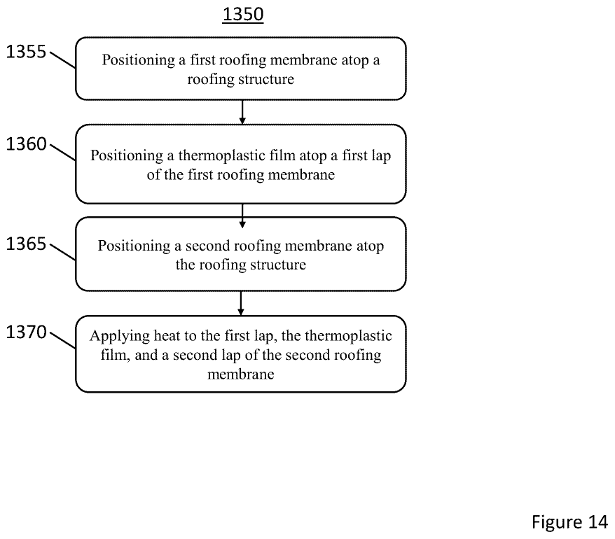

Method 1350 may include positioning a first roofing membrane 106A atop a roofing structure at operation 1355. The first roofing membrane 106A may be similar to those described herein and may include a main body 110A, having a first attachment surface 120A (e.g., a first lap). Method 1350 may include positioning a thermoplastic film 212 atop the first attachment surface 120A at operation 1360. For example, the thermoplastic film 212 may be positioned along all of or a substantial portion (e.g., at least 75%, at least 80%, at least 85%, at least 90%, at least 95%, at least 97%, at least 99%, or more) of the width and/or length of the first lap. In some embodiments, heat and/or pressure may be applied to the first lap and the thermoplastic film 212 to tackify the thermoplastic film 212 to enable the thermoplastic film 212 to bond to the first lap. FIG. 8 illustrates the thermoplastic film 212 adhered to or otherwise positioned on an end lap 118, while FIG. 11 illustrates the thermoplastic film 212 adhered to or otherwise positioned on a side lap 116.

At operation 1365, a second roofing membrane 106B may be positioned atop the roofing structure such that a second attachment surface 120B (e.g., a second lap) of the second roofing membrane 106B at least partially overlaps the first lap and the thermoplastic film 212. The second roofing membrane 106B may be positioned above or below the first roofing membrane 106A in various embodiments. As noted above, each roofing membrane 106A/106B may be constructed of a thermoset material (e.g., ethylene propylene diene monomer (EPDM)) or a thermoplastic material (e.g., TPO), although method 1350 may be particularly useful for thermoset roofing membranes as such membranes cannot be easily heat welded and are typically bonded using various adhesives.

The method 1350 may include applying heat to the first attachment surface 120A, the thermoplastic film 212, and the second attachment surface 120B at operation 1370. For example, once in a desired position relative to one another, the first roofing membrane 106A, the second roofing membrane 106B, and the thermoplastic film 212 may be heated to soften and tackify the thermoplastic film 212. The thermoplastic film 212 adheres to both the first attachment surface 120A and the second attachment surface 120B to bond the first roofing membrane 106A and the second roofing membrane 106B together. FIGS. 9 and 10 illustrate the roofing membranes 106A/106B bonded together at end laps 118, while FIGS. 12 and 13 illustrate the roofing membranes 106A/106B bonded together at side laps 116. The heat may be applied at a temperature of between about 200° F. and to 1148° F. and may be chosen based on the composition and/or thickness of the roofing membranes 106A/106B, the composition and/or thickness of the thermoplastic film 212, a duration of time that the heat is applied, and/or other factors. A variety of methods may be used to heat thermoplastic film 212 based on application and conditions such as, but not limited to, infrared heating, induction heating, plate heating, conduction heating, convection heating, etc. In some embodiments, the heat may be applied using a heat welder and/or applicator, such as those described in relation to FIGS. 6A and 6B above. However, it is envisioned that a variety of tools and machinery may be additionally used to perform the operation as described herein.

In some embodiments, method 1350 may include applying pressure to the first roofing membrane 106A, the thermoplastic film 212, and the second roofing membrane 106B. The pressure applied may help increase the bond between the thermoplastic film 212 and the roofing membranes 106. In some embodiments, the pressure may flatten and/or compress an area of overlap of the first attachment surface 120A and the second attachment surface 120B. More specifically, the overlap of the attachment points 120A/120B may bulge or stick out relative to the remaining portions of the first roofing membrane 106A and the second roofing membrane 106B. Therefore, in some applications, it is beneficial to press down or flatten the overlap point of the attachment points 120A/120B as to create a flush seam (e.g., substantially planar with the remaining portions of the roofing membranes 106) between the first roofing membrane 106A and the second roofing membrane 106B. By applying pressure, the first attachment surface 120A, the thermoplastic film 212, and the second attachment surface 120B may be compressed relative to the rest of the first roofing membrane 106A and the second roofing membrane 106B. The heat and pressure may be applied simultaneously (or substantially simultaneously) in some embodiments. In other embodiments, the heat may be applied first, followed by the pressure, and/or vice versa. The pressure may be applied using a heat welder, applicator, roller, weighted pad, and/or other device.

In some embodiments, the method 1350 may include cleaning the first attachment surface 120A and/or the second attachment surface 120B prior to bonding the roofing membranes. For example, the first roofing membrane 106A and/or the second roofing membrane 106B may have dirt, dust, residual material from production (e.g., materials such as mica that prevent the membranes from sticking to one another), damage, and/or various other imperfections. In some embodiments, a cleaning agent may be applied to one or both of the attachment surfaces 120A/120B to ensure a clean, uniform surface to promote bonding with the thermoplastic film 212. A washrag or other abrasive cleaning tool may be used alone or in conjunction with the cleaning agent remove any debris. It is envisioned that only a portion of or the entirety of the roofing membranes 120A/120B may be cleaned in various embodiments.

In some embodiments, the method 1350 may include flattening the first roofing membrane 106A and/or the second roofing membrane 106B by applying pressure to the first roofing membrane 106 and/or the second roofing membrane 106B. In some embodiments, the first roofing membrane 106A and/or the second roofing membrane 106B may be pressed flat prior to being bonded together. Such flattening may help eliminate any curling, folding, or other warping that may occur during shipping, manufacturing, and/or storage of the roofing membranes 106. The roofing membranes 106 may be flattened by applying heat and/or pressure to the first roofing membrane 106A and/or the second roofing membrane 106B using rollers, pads, other weighted devices, or other methods known in the art. For example, the heat welder and/or applicators as shown in FIGS. 6A and 6B may be used. Once flattened, the surface of the first roofing membrane 106A and the second roofing membrane 106B, and in particular the attachment surfaces 120A/120B, may provide more uniform surfaces that facilitate strong bonding between the first roofing membrane 106A and the second roofing membrane 106B and the thermoplastic film 212. Additionally, heat may be applied during the flattening process as to make the roofing membrane 106 more pliable during the flattening process.

It will be appreciated that any number of roofing membranes may be adhered together in a similar manner to cover an entire roof structure. Each roofing membrane may overlap one or more roofing membranes, and in some instances, each edge/lap of a given roofing membrane may be overlapped with another roofing membrane.

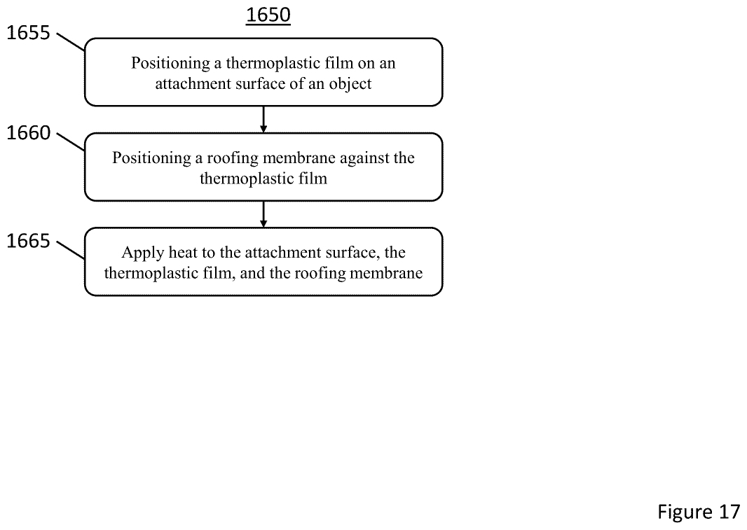

A method 1650 as shown in FIG. 17 for coupling a roofing membrane 106 to a metal, polymeric, and/or other object 1422 (which may be a target object 314 as described elsewhere herein) using a thermoplastic film 212 will next be described. The object 1422 may be part of a roofing accessory, such as a gutter, flashing, support features for objects positioned atop the roof (e.g., solar arrays, antennae, HVAC equipment, etc.), vertical surfaces and/or objects protruding from the roof deck and/or cover boards, and/or other objects. As noted above, the thermoplastic film 212 may be used to couple or secure roof membranes to various roofing structures or materials, which may include support members (e.g., wood and/or metal beams), roof decks, cover boards, insulation layers (e.g., foam and/or other insulation boards), and/or other boards or members. The use of the thermoplastic film 212 may be used with such a method described below to replace or supplement traditionally-used methods of coupling materials, such as ballasting, mechanically fastening, adhesive bonding, heat welding, and other methods known in the art. It is envisioned that the roofing membrane 106 and the metal object 1422 may be interchangeable within this method 1650. For example, the thermoplastic film 212 may be positioned on the metal object 1422 instead of on the roofing membrane. Additionally, method 1650 may provide the significant benefit over existing methods and systems as a singular installer may be capable of performing the methods described herein.

The method 1650 may include positioning a thermoplastic film 212 on a desired location (e.g., an attachment surface 1424) of the object 1422 at operation 1655. For example, the desired location may be a portion of the object 1422 that is to be covered with a roofing membrane 106 to help seal the object with the rest of the roof structure. In some embodiments, upon positioning the thermoplastic film 212 relative to the object 1422, heat and/or pressure may be applied to the thermoplastic film 212 and/or the object 1422. The heat may soften and tackify the thermoplastic film 212 and enable the thermoplastic film 212 to bond with the object. Pressure may be applied to enhance the adhesion in some embodiments.

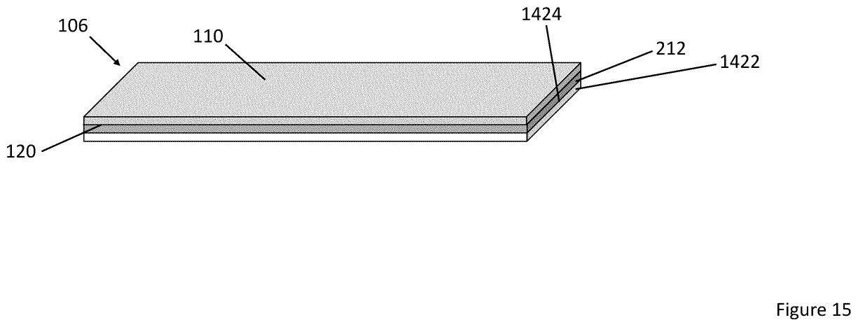

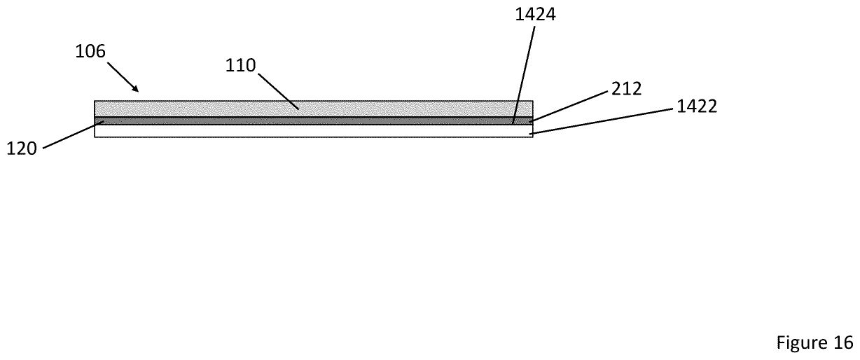

At operation 1660, a roofing membrane 106 may be positioned against the thermoplastic film 212. FIGS. 15 and 16 illustrate the thermoplastic film 212 being positioned at the attachment surface 120. As noted previously, during placement, the thermoplastic film 212 and/or roofing membrane 106 may be moved or repositioned without the thermoplastic film 212 fusing or securing to the attachment surface 120 of the roofing membrane 106. Therefore, during placement and prior to applying heat to the thermoplastic film 212, an installer may remove, move, and/or replace the thermoplastic film 212 and/or roofing membrane 106, enabling adjustments to be made. Method 1650 may include applying heat to the attachment surface 120 of the roofing membrane 106, the thermoplastic film 212, and the metal attachment surface 1424 of the object 1422 at operation 1665. For example, once positioned, the roofing membrane 106, the object 1422, and the thermoplastic film 212 may be heated to soften and tackify the thermoplastic film 212. The tackified thermoplastic film 212 may bond the attachment surface 120 and the attachment surface 1422 and as the melted thermoplastic film 212 begins to cool, the two surfaces will fuse to the thermoplastic film 212. The heat applied may range between about 200° F. up to 1148° F., with temperature being chosen based on a composition and/or thickness of the object 1422, a composition and/or thickness of the thermoplastic film 212, a composition and/or thickness of the roofing membrane 106, a duration that the heat is applied, and/or based on other factors. A variety of methods may be used to heat thermoplastic film 212 based on application and conditions such as, but not limited to, infrared heating, induction heating, plate heating, conduction heating, etc. While described with the thermoplastic film 212 being first applied to the object 1422, it will be appreciated that in some embodiments the thermoplastic film 212 may be first applied to the roofing membrane 106. The thermoplastic film 212 and the roofing membrane 106 may then be positioned relative to the object 1422. In some embodiments, heat and/or pressure may be applied to the thermoplastic film 212 upon being positioned against the roofing membrane 106 to adhere the two components prior to positioning the components against the object 1422.

The method 1650 may include applying pressure to the roofing membrane 106, the thermoplastic film 212, and the object 1422. Such pressure may help improve the adhesion between the thermoplastic film 212 and the roofing membrane 106 and/or object 1422. In some embodiments, the attachment surface 120 of the roofing membrane 106 and/or the attachment surface 1424 of the object 1422 may be cleaned to remove any debris present prior to applying the thermoplastic film 212 and/or roofing membrane 106. In some embodiments, the roofing membrane 106 may be flattened prior to, during, and/or after bonding by applying pressure to the roofing membrane 106.

### EXAMPLE

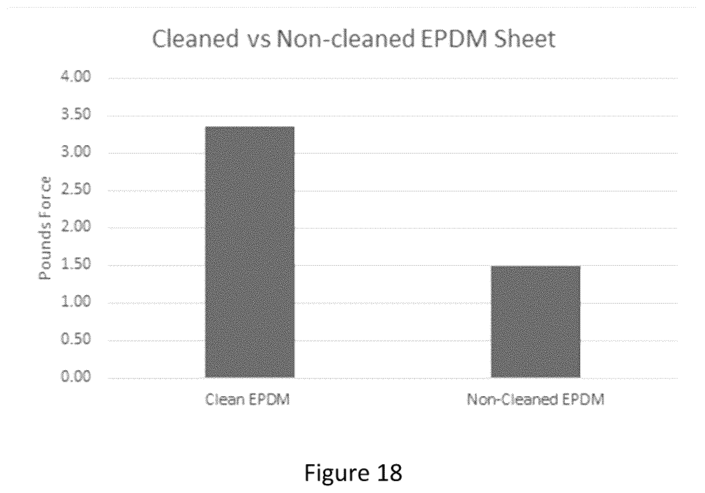

Testing was done to determine the peel strength of membranes applied to cleaned versus non-cleaned EPDM sheets. A thermoplastic film was heat welded to the laps or edges of a cleaned EPDM membrane and a non-cleaned EPDM membrane. Surfaces of the cleaned EPDM membrane were cleaned of mica or talc dusting agent using the techniques described herein. The thickness of the thermoplastic film tested was between 11 to 14 mils, with 12 mils giving the optimum peel strength. The films tested included polyethylene, polypropylene or ethylene vinyl acetate, with polyethylene having the highest peel strength. The thermoplastic film was reinforced with a polyester scrim for strength and to prevent unwanted stretching and/or breaking during the welding processes. The thermoplastic film was welded to the EPDM membrane at a temperature of 1112° F. with a speed 8.85 feet per minute. The EPDM membranes were aligned with the polymer film on the top and bottom EPDM membranes touching. The thermoplastic films were welded together to seal the lap of the EPDM membranes. The EPDM membranes were welded together at a temperature of 1158° F. and a speed of 10.5 feet per minute. As shown in FIG. 18, the peel strength was noticeably higher on cleaned EPDM membrane, with the peel strength of the cleaned EPDM membrane exceeding double the peel strength of the non-cleaned EPDM membrane.

The methods, systems, and devices discussed above are examples. Some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. It will be further appreciated that all testing methods described here may be based on the testing standards in use at the time of filing or those developed after filing.

Specific details are given in the description to provide a thorough understanding of the embodiments. However, it will be understood by one of ordinary skill in the art that the embodiments may be practiced without these specific details. For example, well-known structures and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

What is claimed is:

1. A roofing system comprising:
a first ethylene propylene diene terpolymer (EPDM) roofing membrane comprising a first lap;
a second EPDM roofing membrane comprising a second lap that overlaps at least a portion of the first lap of the first roofing membrane; and
a thermoplastic film positioned between the first lap and the second lap, wherein the thermoplastic film bonds the first lap and the second lap together.

2. The roofing system of claim 1, wherein bonding provided by the thermoplastic film is heat-activated.

3. The roofing system of claim 1, wherein the thermoplastic film comprises a thickness between 5 mils and 30 mils.

4. The roofing system of claim 1, wherein the at least the portion of the second lap that overlaps the first lap is compressed relative to a remaining portion of each of the first EPDM roofing membrane and the second EPDM roofing membrane.

5. The roofing system of claim 1, further comprising a third EPDM roofing membrane including a third lap that overlaps at least a portion of one or both of the first EPDM roofing membrane and the second EPDM roofing membrane.

6. The roofing system of claim 1, wherein the thermoplastic film provides a bond strength of between about 1 force pound and 50 force pounds using the ASTM D 1876 T-peel test.

7. The roofing system of claim 1, wherein each of the first lap and the second lap comprises an end lap or a side lap.

8. A method for coupling roof membranes, the method comprising:
positioning a first EPDM roofing membrane atop a roofing structure, the first EPDM roofing membrane comprising a first lap;
positioning a thermoplastic film atop the first lap;
positioning a second EPDM roofing membrane atop the roofing structure such that a second lap of the second EPDM roofing membrane at least partially overlaps the first lap and the thermoplastic film; and
applying heat to the first lap, the second lap, and the thermoplastic film to bond the first lap to the second lap.

9. The method of claim 8, further comprising applying pressure to the first EPDM roofing membrane, the thermoplastic film, and the second EPDM roofing membrane after positioning the second EPDM roofing membrane.

10. The method of claim 9, wherein the pressure is applied using one or both of a roller and a weighted pad.

11. The method of claim 9, wherein the pressure compresses the lap, the second lap, and the thermoplastic film relative to remaining portions of each of the first EPDM roofing membrane and the second roofing membrane.

12. The method of claim 9, wherein the pressure and the heat are applied at least substantially simultaneously.

13. The method of claim 8, further comprising flattening one or both of the first roofing membrane and the second roofing membrane prior to applying the heat.

14. The method of claim 8, wherein the heat is applied using one or more heat application techniques selected from the group consisting of infrared radiation, heated air, induction heating, and via a heated weight.

15. The method of claim 8, wherein the heat is applied at a temperature of between 200° F. and 1148° F.

16. The method of claim 8, further comprising cleaning one or both of the first lap and the second lap using a cleaning agent.

17. The method of claim 8, further comprising applying heat to the thermoplastic film and the first lap prior to positioning the second roofing membrane to secure the thermoplastic film to the first lap.

18. An EPDM roofing membrane comprising:
a main body including:
a first lap; and
a second lap positioned opposite the first lap; and
a thermoplastic film that is thermally bonded to the first lap.

19. The EPDM roofing membrane of claim 18, wherein the thermoplastic film is secured to a top surface of the first lap.

20. The EPDM roofing membrane of claim 18, wherein the thermoplastic film is configured to thermally bond the first lap with an additional EPDM roofing membrane without use of other adhesive materials.
